(19) United States
(12) Patent Application Publication
(10) Pub. No.: US 2025/0088280 A1
(43) Pub. Date: Mar. 13, 2025

(54) LASER TRIGGERED DISPLAY DEVICE

(71) Applicant: Wi-Charge Ltd., Rehovot (IL)

(72) Inventors: Omer Nahmias, Aminadav (IL); Ortal Alpert, Ness Ziona (IL); Ori Mor, Tel Aviv (IL); Oron Branitzky, Ramat Gan (IL); Lior Golan, Ramat Gan (IL); Simon Nir, Kibbutz Ein Hashofet (IL); Eli Zlatkin, Tel Aviv (IL)

(73) Assignee: Wi-Charge Ltd., Rehovot (IL)

(21) Appl. No.: 18/727,190

(22) PCT Filed: Jan. 7, 2023
(86) PCT No.: PCT/IL2023/050023

§ 371 Date: Jul. 8, 2024

(30) Foreign Application Priority Data
Jan. 7, 2022 (IL) 289682

(51) Int. Cl. H04B 10/43; G01N 21/64; G03B 21/20; H04B 10/50

(52) U.S. Cl. CPC H04B 10/43; G01N 21/6428; G03B 21/204; H04B 10/503

(57) ABSTRACT

New exemplary systems using a laser beam generated by a transmitter unit in abase station, for detecting, communicating with and controlling devices, typically battery-operated, installed in public spaces. Interaction between the laser beam and the device uses a laser detector module on the device, selected to emit a fluorescent signal when the laser beam impinges thereon. A fluorescence detector is installed on the base station, and it detects the incoherent fluorescence emitted by the device when the laser impinges on the device. A wireless data link can implement the exchange of information and instructions between the base station and the device, that may be needed following positive detection of the fluorescent emission from the device. The system may use a laser beam in the short wavelength infra-red (SWIR) region. The detector may provide the device with power for its operation and/or for keeping an installed battery charged.

### FIELD

The present disclosure describes laser technology related to the field of remote information display and interchange within areas having public access, especially as applied to commercial information display in sales areas and shops.

### BACKGROUND

Commercial environments, such as stores and other public buildings may greatly benefit from being able to easily deploy large amounts of electronic information or sales assisting devices in their premises, such as display screens, electronic shelf labels, various sensors, digital cameras and the like. Such systems are able to display digital contents to customers, collect valuable data and provide higher revenues and lower cost of ownership to the property. Display screens may present information, such as information about products, whether relating to price or content, such as nutritional value for example, advertising, warnings, and current information, such as the existence and time limits of discounts on the product, while sensors may sense human presence, temperatures, and electronic signals.

Currently, such deployment on a large scale often has to be performed over a large area and rapidly, and can thus result in poor location of the devices themselves, or in inaccurate documentation of where each device is. For example, should a supermarket employee need to install 1000 display screens on different shelves, by going around the premises and mounting the screens one by one to the shelves, the possibility of human error may make it difficult to know which screen is on a specific shelf.

Location awareness is used on many existing screen, sensor or camera devices, such as smartphones, and such devices are able to transmit their location and may also show dynamic content based on location. Wireless laser tags are another remote information providing system, which provide remote tracking, such as is shown in U.S. Pat. No. 7,229,017 for “Laser Locating and Tracking System for Externally Activated Tags” to E. A. Richley et al, and US Published Patent Application No. 2015/0022321 for “Long-Range Electronic Identification System” to D. K. Lefevre.

There is significant monetary value for operators of such locations in devices such as information screens, sensors, cameras, and similar devices, that enable automatic location and information exchange in public places.

However, many of such current systems are limited in their scope. For instance, lack of functionality can arise when the public place and its devices are located significantly inside a building, where GPS access is limited, or has poor ability to distinguish between nearby items.

The disclosures of each of the publications mentioned in this section and in other sections of the specification, are hereby incorporated by reference, each in its entirety.

### SUMMARY

The present disclosure attempts to provide novel systems and methods that overcome at least some of the disadvantages of prior art systems and methods, and describes new exemplary systems, which, using a laser beam generated by a transmitter unit in a base station, detect, communicate with and control devices, typically battery-operated, installed in public spaces. The interaction between the laser beam and the device is achieved by equipping the device with a laser detector, selected to emit a fluorescent signal when the laser beam impinges thereon. A fluorescence detector is installed on the base station, and it is capable of detecting the incoherent fluorescence emitted by the device when the laser impinges on the device. A wireless data link can implement the exchange of information and instructions between the base station and the device, that may be needed following positive detection of the fluorescent emission from the device. The system may be advantageously operated using a laser beam in the short wavelength infra-red (SWIR) region, and detection of the beam may be performed by an SWIR laser detector, which may be a photovoltaic cell, a PIN diode, an APD diode, or any other suitable detector, to detect when an SWIR laser impinges thereon. The detector may further be adapted to provide the device with power for its operation and/or for keeping an installed battery charged.

The fluorescent signal is generated by a fluorescent material on or in the device, typically deposited on or near the laser detector, or embedded in the laser detector. Upon impingement of an SWIR laser, the system is adapted to react in at least one of the following two ways:

1. The fluorescent material emits its fluorescence light, which facilitates detection of the device by an external detection device such as an infrared camera, or an infrared detector, or a detector located within the laser emitting base station. The fluorescence signal may also be used to provide a first unique signature, differentiating the device from other objects in its vicinity which may be emitting or reflecting light. The fluorescent light is specific to the fluorescent material used and to the laser used. For example, illuminating Ho:YAG nanocrystals with a 1.9 μm SWIR laser, causes fluorescence at around 2.122 μm, which can be easily detected. This is a very different wavelength from other materials found in a typical environment, which generally do not respond to the 1.9 micrometer laser, or, in the rare case that they do, do not emit 2122 nm fluorescence. The absorption wavelength can typically be tailored to specific laser wavelengths by using semiconductors or semiconductors powder, for example III-V compounds may be tuned from approximately 800 nm all the way to 2200 nm, thus providing a unique fingerprint for the device. Thus the fluorescent material is identifiable by two factors, a unique absorption, tailored to the SWIR laser, and a unique emission, differentiating the devices response from that of the environment.
2. A controller in the base station receives the signal from the SWIR laser detector, and responds by at least one of:
(a) Sending a wireless signal transmission back to the device, containing information of what to show on the device, and
(b) Signaling a user, generally the device installer, for example by outputting a signal to a screen, a speaker, or an electronic signal. This signal can be a visual or auditory signal for the technician, for instance causing the technician's terminal to beep and indicate a “device successfully paired” signal).

It is possible to identify the specific location of the targeted device by noting the aiming direction of the laser transmitter, and to determine the type and capabilities of the targeted device, according to the responding signals, differentiating it from other illumination in the region, and different nearby devices, for instance, by aiming the laser at a first device, then at a second device, and analyzing and comparing the fluorescent signal and/or the wireless response. This is because only the device at which the SWIR laser is aimed, will respond and emit its characteristic fluorescent signal, and upon detection of the SWIR laser by the SWIR laser detector, the base station controller may instruct the wireless data transmitter to send a wireless identification signal, which uniquely identifies the specific device, thereby providing even more data. The fluorescence response carries very little information, it usually confirms the presence of a device, rather than the device type. It is impractical to use a different laser and detector for each device, so they all use the same laser and the same detector. It is difficult to put a different chromophore on different device screens, though it is possible to provide limited information, such as the type of device detected. Thus, the fluorescence signal simply tells the base station “a device is found here”, while the electronic signal can provide the base station with substantially more identifying and functional information, such as “Device #123456, a type 78 device capable of A, B, C, communication on channel 9, Battery; fully charged, Device ready”.

In a typical system, a filter may be used to filter out sunlight and transmit the laser light, which is absorbed by the SWIR laser detector. Either the filter, the SWIR laser detector or another component in the laser path is configured to emit fluorescence in response to the laser light, facilitating detection of the signature of the device even if it is powered off. In most system it is possible to utilize the detector itself to emit the fluorescent radiation, in such a case it is possible to control the amount of fluorescence by controlling the impedance the detector experiences. When the system is operating, the detector has a lower impedance, and vice versa when not operating. Expressed alternatively, when the system is operating, the photons are using their energy to generate a photovoltaic current, and hence have less redundant energy for generating fluorescence emission. When the device is not fully operational, and no photovoltaic current is generated, the fluorescence level is higher than that when the device is powered off.

If the device is turned “on”, the SWIR laser detector controller is configured to transmit a wireless signal including information about the device such as its ID, properties of the laser detected, such as pulse structure, timing, power, and in most cases, also the device type.

A typical routine that would occur when the system is in use would thus follow at least most of the below sequence, comprising the following occurrences:
i. Detection of an SWIR laser impinging on the SWIR laser detector.
ii. If the device is off, emitting fluorescence in a characteristic band and at a first intensity level.
iii. If the device is on, typically emitting fluorescence at an intensity level less than the first intensity level emitted when the device is off.
iv. Receiving the signal from the detector in a controller.
v. If the controller is off, an additional step of turning the controller is now actuated.
vi. Sending from the controller to the base station, a wireless data transmission in response to the signal detection, the wireless data transmission including identifying information about the device, and other information that may be necessary for correct action by the system.
vii. Transmission from the base station of a return wireless data transmission in response to the identity and other information regarding the device, for example, relevant content to be displayed on a screen of a screen-enabled device, the aimed direction of the camera view for a camera-enabled device, or a lock/unlock instruction for a lock-enabled device.
viii. Using the data at the device, for example, by or for: Presenting an adaptation of the data on the screen.
   Turning the device on or off.
   Changing the device settings.
   Presenting content from a database, on the screen.
   Pointing the device at a different direction.
   Playing a sound.
   Reconfiguring the device.
   Transmitting data from the device.
   Changing the device temperature.

The time taken to locate the devices may be important for three purposes. The first is to verify the correct installation of the device. The sooner the confirmation of the installation position and the correct response to the SWIR laser is obtained, the sooner can the installation technician or the store personnel move on to the next installation. The second is for performing an inventory scan, and for locating the devices in a specific area. The third is to verify the line of sight of the base station to all of the specific locations of devices, such as down a complete aisle.

The system can be used for centralized management of the area where the system is installed. Such a management system can show the location of each device and allows for simple control of each device, for example, by sending a data packet to a specific device based on its location.

Such a management system may show a view of the area, typically a store, the view most conveniently being a plan view, with the devices in the store marked according to their location. An operation such as a mouse click, may enable sending content to the device based on its location within the store, and such content may be graphic, or instruction code, or a file, and may be used to display on the screen of the device, content such as advertisements or price reductions. Some of these screens may be incorporated on malfunctioning devices, as identified by their fluorescence and/or retroreflection response, and are known to be malfunctioning either because no data packet response was transmitted to the base station, or a data packet response positively indicating a problem was sent, or any other indication that a problem exists.

In response to the indication of a problem, the store management may send an employee or a robot to fix the problem, for example by replacing the battery or by relocation of a wireless power supply device, or alternatively, it may be possible to correct the problem wirelessly, such as by wirelessly rebooting the device or by wirelessly supplying power to the device, or by updating parameters or software, either remotely or by instructing local maintenance staff. This whole process may be done automatically, even without presenting the store image to a staff member of the store.

This management interface further allows updating settings or content on the devices, for example, automatically, or manually sending a data file to a certain device which causes it to display on its screen, a specific content to customers.

Further applications and details of the setting up and operational methods of specific systems, are provided in the Detailed Description section of this disclosure.

There is thus provided in accordance with an exemplary implementation of the devices described in this disclosure, a system for monitoring at least one electronic device in a region of interest, the system comprising:
(i) a laser scanner unit for transmitting a laser beam into the region of interest,
(ii) a laser detector module mounted on at least one electronic device, the laser detector module adapted to emit fluorescent illumination when the laser beam impinges thereon, and
(iii) a fluorescence detection module on the laser scanner unit, adapted to notify a system controller of the detection of fluorescence illumination from the laser detector module on the electronic device,
wherein the at least one electronic device has at least a lower state of electronic activity, and a higher state of electronic activity, and the intensity of the emitted fluorescent illumination on impingement of the laser beam on the laser detection module is dependent on the state of electronic activity of the electronic device. In such a system, the intensity of the fluorescence illumination may thus provide an indication of a non-functioning electronic device.

In such a system, the electronic device may further comprise a wireless transceiver adapted to enable transmission of data from the laser scanner unit to the electronic device, on notification by the system controller of detection at the laser scanner unit, of fluorescence illumination from the electronic device, wherein the data transmitted to the electronic device comprises at least one of information for display by the electronic device, or instructions for execution by the electronic device.

In any of the above described systems, wireless transceiver is further adapted to enable transmission of data from the electronic device to the laser scanner unit, the data comprising at least one of identity information of the electronic device and an electronic status of the electronic device.

Furthermore, any of the previously mentioned electronic devices may further comprise a battery to enable its operation, and the laser beam is then operative to provide power for charging the battery.

Additionally, the laser scanner unit may further comprise a scanning mirror adapted to scan the region of interest such that the laser beam can locate the position of an electronic device in the region of interest by detection of the fluorescence illumination generated by impingement of the laser beam on the electronic device.

According to yet further implementations of the systems mentioned hereinabove, the laser detector module on the device may comprise an optical filter adapted to reduce the sensitivity of the laser detector module to daylight. Furthermore, the laser beam may have a wavelength within the short wavelength infra-red (SWIR) region.

In yet other implementations of the systems of the present application, the electronic device may be any of an electronic faucet, a remote electronic sensor, an information display screen, an electronically operated window shade, an electronically operated window, an electronic label, and an electronically operated camera system.

There is further provided, according to more implementations of the present disclosure, an electronic device for communicating with a base station, the electronic device comprising:
(i) a laser detector module adapted to emit fluorescent illumination, and to enable output of an electrical signal, when a laser beam from the base station impinges on the laser detector module,
(ii) a wireless transmitter adapted to transmit a data package from the electronic device to the base station when a device controller receives the electrical signal from the laser detection module indicating impingement of the laser beam from the base station, and
(iii) a wireless receiver adapted to receive from the base station at least one of (a) information for display by the electronic device, or (b) instructions for execution by the electronic device, if the base station detects from the device, at least one of fluorescence illumination or a data package.

In such an electronic device, the data package sent to the base station may comprise at least one of identity information of the electronic device, or a state of electronic activity of the electronic device. In either of the previously described electronic devices, the intensity of the fluorescent illumination on impingement of the laser beam may be dependent on the state of electronic activity of the electronic device. In the latter case, the intensity of the fluorescence illumination should be able to provide an indication of a non-functioning electronic device.

Furthermore, the electronic device may further comprise a battery for its operation, and the laser beam may then be operative to provide power for charging the battery.

In such an electronic device, the laser beam from the base station may be configured to scan a region in which the electronic device is situated, such that the laser beam can locate the position of the electronic device in the region by detection of the fluorescence illumination generated by impingement of the laser beam on the laser detector module of the electronic device.

According to yet further implementations of the electronic devices mentioned hereinabove, the laser detector module on the device may comprise an optical filter adapted to reduce the sensitivity of the laser detector module to daylight. Furthermore, the laser beam may have a wavelength within the short wavelength infra-red (SWIR) region.

In yet other implementations of the systems of the present application, the electronic device may be any of an electronic faucet, a remote electronic sensor, an information display screen; an electronically operated window shade, an electronically operated window, an electronic label, and an electronically operated camera system.

In yet another implementation of the systems of the present disclosure, there is provided a system for communication with at least one electronic device in a region of interest, the system comprising:
(i) a laser scanner unit for transmitting a laser beam into the region of interest,
(ii) a laser detector module mounted on an electronic device, the laser detector module adapted to emit fluorescent illumination when the laser beam impinges thereon,
(iii) a fluorescence detection module on the laser scanner unit, adapted to notify a system controller of the detection of fluorescence illumination from the laser detector module on the electronic device, and
(iv) a monitoring system adapted to remotely monitor the electronic device wirelessly, for receipt of information from the system controller indicating detection at the laser scanner unit of fluorescence illumination from the electronic device, and, on receipt of information from the system controller indicating detection at the laser scanner unit of fluorescence illumination from the electronic device, enable control of at least one function of the electronic device.

In such a system, the information from the system controller may further comprise at least one of identity information of the electronic device and an electronic status of the electronic device. Furthermore, the control of at least one function of the electronic device may comprise at least one of instructing the electronic device to display information, or instructing the electronic device to execute a predetermined function.

In any of those described systems, the intensity of the fluorescence illumination may provide an indication of a non-functioning electronic device.

Furthermore, the electronic device may further comprise a battery for its operation, and the laser beam may then be operative to provide power for charging the battery.

In these electronic devices, the laser beam from the base station may be configured to scan a region in which the electronic device is situated, such that the laser beam can locate the position of the electronic device in the region by detection of the fluorescence illumination generated by impingement of the laser beam on the laser detector module of the electronic device.

According to yet further implementations of the electronic devices mentioned hereinabove, the laser detector module on the device may comprise an optical filter adapted to reduce the sensitivity of the laser detector module to daylight. Furthermore, the laser beam may have a wavelength within the short wavelength infra-red (SWIR) region.

In yet other implementations of the systems of the present application, the electronic device may be any of an electronic faucet, a remote electronic sensor, an information display screen; an electronically operated window shade, an electronically operated window, an electronic label, and an electronically operated camera system.

### BRIEF DESCRIPTION OF THE DRAWINGS

The present invention will be understood and appreciated more fully from the following detailed description, taken in conjunction with the drawings in which:

FIG. 1 shows schematically a typical shopping shelf setting in which the devices of the present invention, and a system using such devices, may be advantageously used;

FIG. 2 is an enlarged portion of one of the shelves of FIG. 1, showing a fluorescent signal emitted from a device in response to an SWIR laser beam impingement;

FIG. 3 illustrates a typical plan view of a store showing the location and status of several devices located on different shelves and display aisles of the store;

FIG. 4 illustrates a simplified block diagram of a typical device used in applications such as those of FIGS. 1 to 3;

FIG. 5 shows a spectral plot of the solar radiation reaching earth;

FIG. 6 shows the complete electro-magnetic radiation spectrum from UV to Microwaves; and

FIG. 7 shows an additional safety feature of the presently described SWIR laser scanner, used to increase the safety of operation of the system, by protecting the system and users in the event of an unexpected short circuit within the device.

### DETAILED DESCRIPTION

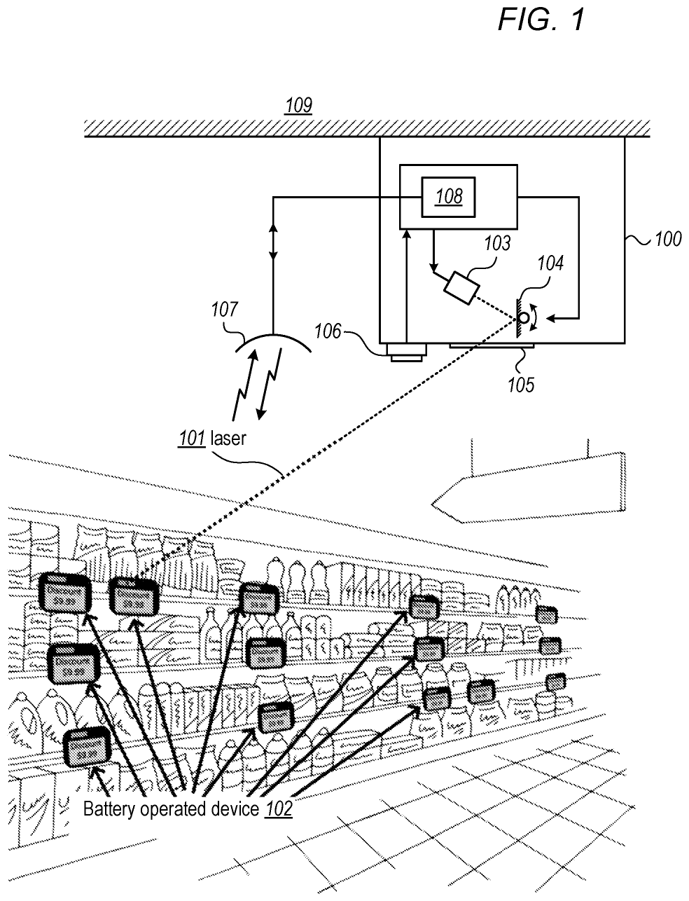

Reference is first made to FIG. 1 which illustrates schematically an exemplary setting in which the devices of the present application, and a system using such devices, may be advantageously used. FIG. 1 shows a pictorial representation of a typical commercial setting, in this example, the display aisle of a store. Other areas of use and other applications for the inventive concepts of this disclosure have been described later in this disclosure, but the store example has been used as a non-limiting example of an application for describing many of the details of how the system and its methods operate. It is to be understood, though, that the details specific to the store implementation are not intended to reduce the general applicability of the presently described system and devices in other areas. In the exemplary application of FIG. 1, there are shown many devices 102 according to the present disclosure, installed at suitable positions on the shelves of the aisle. In the example shown in FIG. 1, the devices 102 are equipped with a screen showing information and such as an electronic shelf location or a product label, or as a more general information screen, or the device may incorporate a sensor to determine the location of the device, or the device may incorporate an imaging or inspecting apparatus enabling the determination of the number of products still present on the shelf, or the presence of purchasers in the vicinity of the device, or any other function which such an intelligent device can be called upon to perform in such a setting. In FIG. 1, all the devices are shown having a similar appearance, having display screens, but in a real life setting, the devices may have different functions and therefore different appearances. In the exemplary setup shown n FIG. 1, a base station 100, also known as a laser scanner unit, is shown installed in a position where it can survey the whole of the area to be controlled, and in this case, it is installed on the ceiling 109 of the aisle, though any other suitable location would be equally useful. The base station incorporates a laser emitter 103, which can advantageously be a Short Wavelength Infra-Red laser, called an SWIR laser henceforth, which transmits a laser beam 101. The base station 100 also incorporates a scanning device 104 such that the laser beam 101 emitted from the base station 100 can be directed through an optical window 105 at any part of the region under the control of that base station. The beam 101 scans the surroundings until it encounters one of the devices 102, or it is directed to the chosen device 102 by the scanner controller, according to an instruction which the system provides to it in accordance with the task in hand.

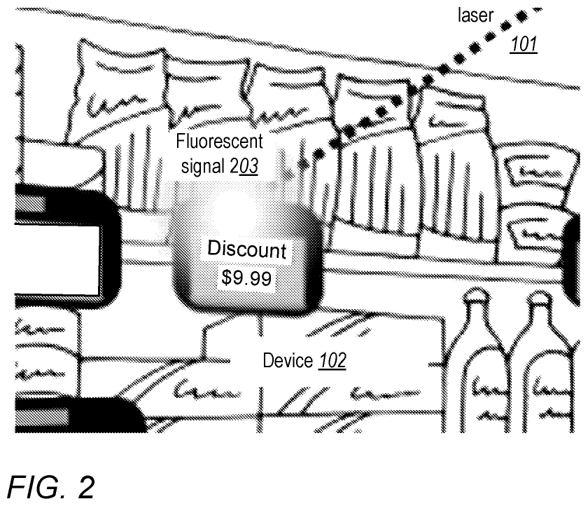

When the SWIR laser beam 101 impinges on a device 102, and as shown in FIG. 2, the device emits fluorescent light 203 which may be remotely detected by a detection device 106 on the base station, to define the presence of the device 102 and also to obtain information about the state of the device. In a first instance, the level of the fluorescent radiation emitted by the device can provide information about the operational status of the device.

Typically, if the device is non-operational, such as by being off, or in a sleep or hibernation mode, a fluorescent signal emitted from the photovoltaic cell has a higher level than from a device that is turned on and operational. The reason for this is that when the photovoltaic cell is not powered, the impingement of photons of the SWIR laser beam on the photovoltaic cell does not generate a photoelectric current, but these photons must give up much of their energy somehow, so it is used to generate fluorescence, and additional heat. The level of the flux is inversely proportional to the impedance of the photoelectric cell, which is highest when it has no applied voltage. This feature of emitting fluorescence even when the device is not operational, enables the base station to detect devices even when they are off or sleeping, with no less reliability than when operating. It also enables the identification of “off devices” easier, this being a useful feature if there is a problem preventing their operation, enabling the solving of the problem, for example by supplying power to them, or by turning them on. Once operational, the device can transmit a wireless data packet indicating its identity ID and its “ready” status. In an environment such as a store, where multiple devices are operating and some may not be operating, identifying the status of each device is critical for business performance. The presence of many such devices in the same space may create a problem in identifying the location and status of each device quickly and efficiently, and of providing relevant content to the devices.

Location functionality, using the SWIR laser, may also be achieved by adding a retro-reflector to the device, or a filtered retro reflector which will reflect only the SWIR laser wavelength. This retroreflected beam is detected by a detector in the base station. The advantage of a retro reflector over that of detecting fluorescence emission, is that it is quicker to respond, and may be smaller and of lower cost, and can provide a signal of intensity tens of dB greater than the fluorescence signal, but its level cannot be controlled. Consequently, it is impossible to distinguish between a device that is not operational, and a device that is operational, but for instance, whose data transmission is somehow blocked. Blocking of the data transmission may occur for instance, as a result of the IR electronic channeling diode being covered by a price tag, or, by inadvertent location of a device behind another object on the shelf. If the feature for determining the operational status of the devices is not necessary, it may be possible to use a retroreflector instead of a fluorescent signal. It is also possible to use a retro reflector in addition to a fluorescent signal to allow detection of the devices by redundant methods.

FIG. 2. shows an enlarged portion of one of the shelves of the shopping aisle shown in FIG. 1, showing fluorescent signal 203 emitted from the device 102 in response to SWIR laser 101 impinging on the device. The fluorescence is emitted incoherently, and at a wavelength longer than that of the SWIR laser 101, but generally also in the SWIR region of the spectrum. Since the fluorescence emission is incoherent and uncollimated, the level of the illumination at a remote location, such as at the base station, may be orders of magnitude less than the laser beam power intensity, but should be readily detected by a detector 106 on the base station. Other functional elements of the base station 100, are described hereinbelow in the paragraph describing the SWIR Laser Scanner hereinbelow.

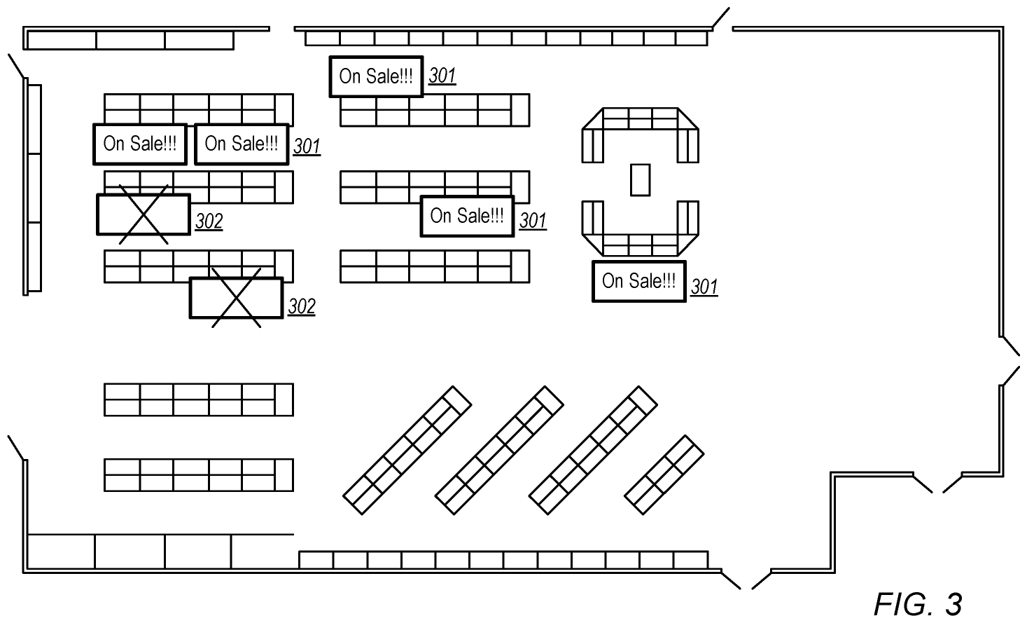

Reference is now made to FIG. 3, which illustrates a typical plan view of a store showing the location and status of several devices located on different shelves and display aisles of the store. Some of the devices 301 respond to the impingement of the SWIR laser, with a lower level fluorescent signal, and a corresponding wireless data package, both of which indicate normal operation. Other devices 302 may be either offline, off, or have a malfunction, and therefore emit a fluorescent signal having a higher level of intensity than those of operating devices 301, such that a problem in those devices 302 is indicated. If the devices off, then no wireless data package will be generated.

The potential problematic devices 302 may be detected by noting any of:
1. A higher fluorescent signal.
2. A lack of data packet.
3. A data packet indicating a problem.
4. A missing device where a device was previously detected.
5. A retroreflected signal and the absence of a data packet.
6. A retroreflected signal and a data packet indicating a problem.
7. A fluorescent signal without a retroreflected signal.
8. A retroreflected signal without a fluorescent signal.

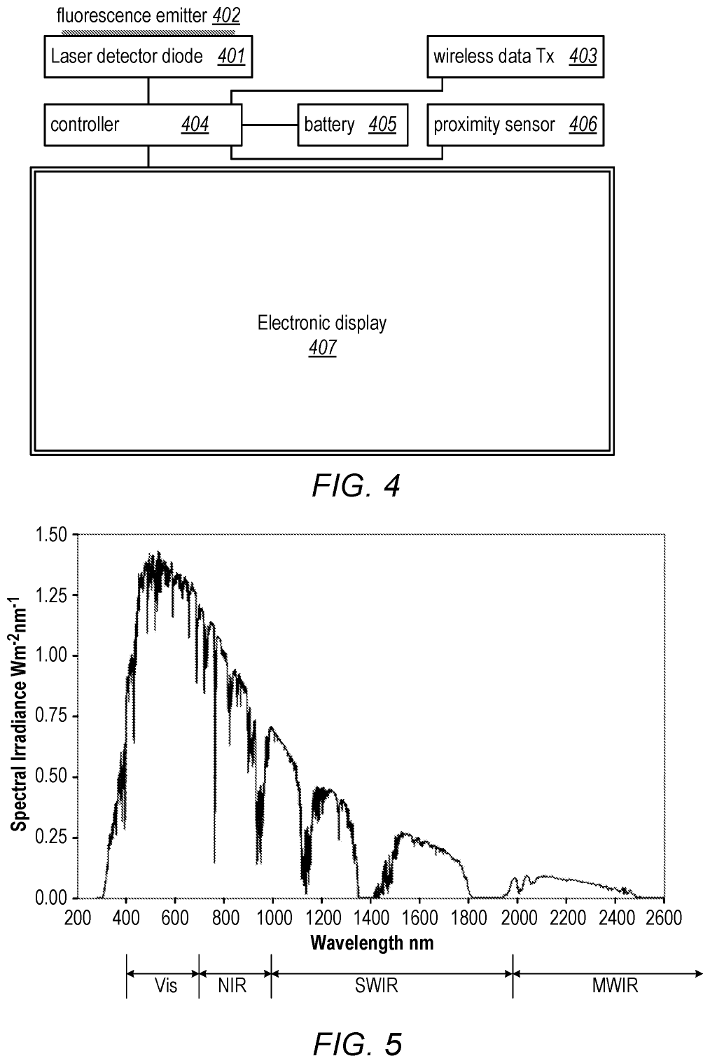

Reference is now made to FIG. 4, which illustrates a simplified block diagram of a typical device used in applications of the present disclosure. The SWIR laser detector 401 is either covered with. or coated with, or embedded in, or embeds the fluorescence emitter 402, or is disposed in the vicinity of the fluorescence emitter 402. Alternatively, one or more of the semiconductor layers of the detector itself may emit a fluorescence signal in response to the SWIR laser. The SWIR laser detector 401 outputs its signal to SWIR laser detector controller 404, typically through converting circuits, such as DC/DC converters, analog to digital converters, MPPT circuits, voltage and current sensing circuitry, and even other processors or communication channels, such as CANBUS or I²C. If the controller 404 is on, it can configure at least one of such circuits to attenuate the fluorescent signal, for example by changing either the temperature, the impedance or resistance on the SWIR laser detector, or the capacitance across it. By this means, the base station can determine if the circuit is on or off, since if the controller 404 is off, no attenuation will occur. If controller 404 is off, or is in a low power state, such as sleeping or hibernating, it may be turned on in response to the signal from the SWIR laser detector 402. Once the controller is operational, it is configured to send a wireless data packet to the base station, in response to an indication from SWIR laser detector 401 of the impingement of an SWIR laser beam. The wireless data packet is sent using data transmitter or transceiver 403, and may include an ID, and other data such as the status of the on-board battery 405, or a proximity sensor 406 or other sensors that may be connected to controller 404. Controller 404 is also connected to auxiliary device 407 which typically may be an electronic display for providing information to the surroundings of the device, or some other component. The wireless data packet sent may further return the status of a metered value, which may be used for billing or subscription services such as
1. The amount of power consumed by the device
2. The amount of power consumed by the device in a time frame
3. The total usage time
4. The total usage time in a specific state, such as “screen on” state.
5. The number of a metered occurrences, such as the number of people that approached the device as recorded by the proximity sensor.
6. The amount of data received or transmitted by the device.
7. The number of time a button was pressed or the number of times the device was touched.
8. A barcode scanned by the device
9. The content processed by the device
10. Another performance meter
11. Number of items change on a shelf
12. An image of the surrounding of the device or an adaptation of it.
13. Data extracted from sensory data captured from the surrounding of the device Controller 404 may receive data packets through transceiver 403 or another wireless transceiver, and may use those to configure the attached subsystem 407.

Most of the fluorescence signal, whether at a full level or attenuated, is typically emitted in a solid angle of at least 0.85 steradian, and typically can be detected from approximately 4.5 steradians, albeit at such large angles it may be difficult to differentiate attenuated from non-attenuated signals. The signals can also typically be detected at distances of up to 30 m, as long as there is a line of sight from the device to the base station. Generally, this is ensured by impingement of the SWIR laser beam along essentially the same path. Hence the SWIR laser beam and the fluorescent signal may be used to identify which devices are visible from specific points, such as from the customer's position of view, or from a camera, such as a security camera or an inventory tracking camera, or from a robot's position of view, or from a charging device's position of view.

Reference is now made to FIG. 5, which shows a spectrum of the solar radiation reaching earth, and is presented to show why SWIR lasers are preferred for use in this device. It can be seen that the irradiance in the SWIR region is much lower compared to the NIR and the VIS regions. UV radiation is dangerous and should not be used for this application. MWIR detectors are very temperature dependent, and typically are less available and hence more expensive for the current application. VIS and NIR lasers may be used, although indoors only, and without direct exposure to sunlight. The laser detector, should be configured such that it only generates a signal in response to the laser beam. If the detector were to generate a signal in response to sunlight, the system would not be easily operable. As is seen from FIG. 5, wavelengths above 1100 nm offer much lower spectral irradiance, compared to the wavelengths in the NIR and VIS regions. A laser in the SWIR part of the spectrum may be a diode laser, and both detectors and lasers for this region are widely available. For example, a 1 mW 1500 nm laser typically having a bandwidth of less than 5 nm, is of low power, low cost, small and safe. Detectors for 1500 nm are also widely available. The irradiance of such a laser, if focused to a beam of 1 cm² would be 2 Watt/m²/nm, which is approximately 10 dB more than the solar spectrum in that region. Combined with a suitable filter transmitting predominantly the laser wavelength, detection of the laser is possible even in direct sunlight. On the other hand a 532 nm laser (common second harmonic of the Nd:YAG laser wavelength) having the same parameters, would be very difficult to discriminate from sunlight.

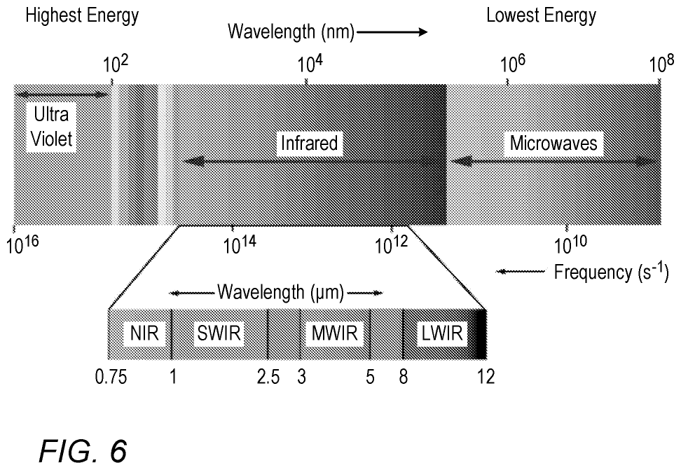

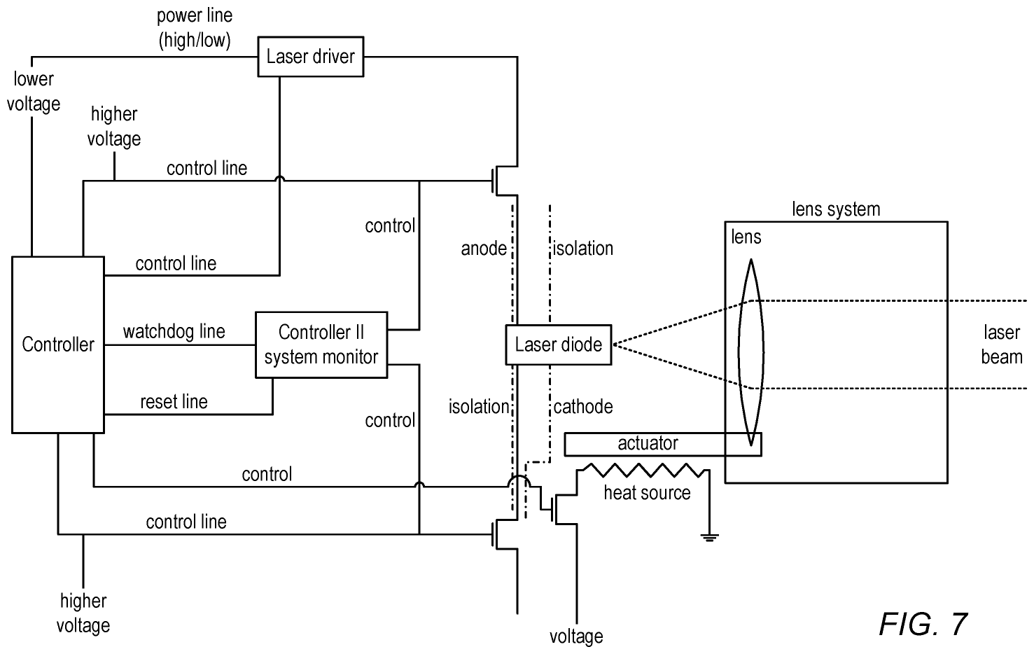

Reference is now made to FIG. 6, which shows the complete electro-magnetic radiation spectrum from UV to Microwaves. This graph is one of various sources, and is used to define the SWIR spectral region used in this disclosure. The graph is sourced from: https://www.edmundoptics.com/knowledge-center/application-notes/imaging/what-is-swir/Other sources define SWIR as the wavelength between 1 micron and 2.0 microns, as shown in FIG. 5, or between 0.9 micron and 1.7 micron. In this disclosure, SWIR is defined as the wavelength range between 1 micron and 2.5 micron.

A number of features and methods of setting up and operating the system are now outlined, to present additional novel uses and methods of use of the systems of the present disclosure.

### Modes of Installation and Uses of the System.

During installation, the device may be configured to be in “installation mode”. During this procedure, the SWIR laser scans the area rapidly, in an effort to reach the device sought as quickly as possible. The SWIR laser scanner may be caused to scan the room as a result of an instruction issued by the device. In installation mode, upon detection of the impingement of the SWIR laser, the device informs the system that it is installed and operational so that the system may register it and its location. It also typically informs the installer that its setup is successful, for example by showing an OK signal on the screen.

While the devices described hereinabove, have generally been described as intended to provide information, and therefore are equipped with a screen, the system can also be used for devices for other purposes, without a screen. One common application is for the control of cameras, and especially security cameras (used as the non-limiting example in this description), traffic cameras, or crowd control cameras. The same advantages as have been described hereinabove in the store scenario, namely rapid discovery, quick positive feedback on correct installation, reporting of the line of sight, centralized management, and the ability to remotely detect a faulty device or a device not activated, can also be advantageously used in such a camera system. Though the security camera device does not need a screen, it may need a pan/tilt stage for aiming in a desired direction, and/or zooming instructions for closing in on an area of interest. Therefore, in the context of the currently described system, upon detecting the impingement of the SWIR laser, the camera module would emit a fluorescent signal, typically indicating the state of the controller in the camera module, and then send out a wireless data packet, assuming that the controller is operational. In response the management system or central surveillance facility would record the position of the camera, and would enable the sending of instructions to it, which could include any or several of pan, tilt, zoom, download, and firmware update functions, or any other instruction required to utilize the facilities of the security camera device.

Electrically Operated Faucets Another device which may benefit from the currently described systems is an electric faucet, activated by the user's hand motion in the field of view of the hand detector. While the problem of locating the position of faucets or other water valves is generally unimportant relative to the problem of locating portable screens or cameras, the abilities described in this application, including the detection of whether the faucet controller is turned on or off, is very advantageous, since a faulty electric valve may be a critical problem, needing rapid detection and repair. Thus, for example, battery replacement or replacement of a damaged part can be detected and repaired rapidly.

### Remote Sensors

Another type of device which may benefit from the systems of the present disclosure are remote sensors. While sensors, like the camera systems mentioned above, may not require a screen, even though there are sensors which do include a screen for showing the measured value, such as temperature sensors, the locating of sensors in a large industrial installation, for instance, and determining their operational status, would be a very advantageous undertaking, especially for maintenance operations on such an industrial installation. In the case of such sensors, the SWIR laser detects the location of the sensors, and the system determines their operational state based on measurement of the fluorescence generated in the device and on the consequent digital response, and may then send content wirelessly to the sensors in order to ensure accurate measurement. Such content could include calibration updates, a measurement schedule, firmware updates, or other necessary inputs which can be sent wirelessly to the sensor.

### Electrically Operated Shades

Yet another type of device which may benefit from use of the current system and its control of remote devices are electrically operated shades. While typically, such shades do not come equipped with a screen, the current electric shade device, if equipped with a screen, may also serve to show temperature, time, weather, illumination details and other valuable data relating to the functionality of the shade. In a commercial setting, such shades may be powered by a battery, or be equipped with a backup battery, or powered by a wireless power system. In such a setting, it is difficult to know from afar if a shade is operational or not, and accessing it physically is time consuming, since it generally requires bringing a step ladder to access the shade operation mechanism. The ability of the current devices to enable identification of the operational state of the shade from afar, using the SWIR laser system of the present disclosure, is very useful. Following the identification of the device using the SWIR laser, and the data response, if returned, the system may then send commands to the electric shade, and to perform such actions as updating its software, charging its battery, or ordering a replacement battery.

### Electrically Operated Windows

Another type of devices which may benefit from use of the current system and its control of remote devices, are electrically operated windows, meaning windows which electronically change their optical properties. Some of such window operational devices may also be equipped with the screen of the current devices, such as to show temperature, time, weather, illumination details and other valuable data. In a commercial setting, such windows may be powered by a battery, a backup battery, or from a wireless power system. In such a setting, it is difficult to know if a window is operational or not from afar, and accessing it physically is time consuming, since it generally requires bringing a step ladder and a screwdriver to access and repair it. The ability of the current device to enable identification of the state of the product from afar using the SWIR laser is very advantageous. Following the identification of the device using the SWIR laser, and the data response if should return, the system may then send commands to the electric window, and to update its software, charge its on-board battery, or order a battery replacement, or any similar maintenance or repair activity.

### Electronic Shelf Labels

There are a number of aspects of the systems of the present disclosure which enable the implementation of electronic shelf labels. Thus for instance, the screen attached to the systems described hereinabove may also serve as a smart electronic shelf label, is content can be changed remotely according to the requirements of the store management. In a similar manner, the camera or sensors attached to the currently described systems, may also serve as the major components of a smart shelving system.

### Device Installation Aids

Another feature of the systems of the present disclosure is the ability to aid an installer in the correct installation of the device itself. Installing the device in a situation where there is no line of sight from the device to the SWIR laser emitter, may cause a number of problems, ranging from the blocking of RF signals by metallic objects in the line of sight, to the simple inability to view or update the device status on the facility's central control screen. For that reason, the device may include an output ability, capable of informing the installer if the SWIR laser is aimed at the SWIR laser detector, or not. Such an output ability may be a notification on the device screen, an indicating LED, a sound emitting system or a wireless notification to the installer. The device may also include an input mechanism, such as a press button, or a special mode which may be initiated locally or from a wireless network. The input mechanism may cause the device to behave differently from its normal operation for a short time, for example by sounding a unique “beep”, turning on/off a LED diode in a specific pattern, or displaying an installation message on a screen. Typically, the device may switch back to the normal operation mode after a predefined time, ranging for instance from 1 minute to 24 hours, or as soon as the SWIR laser has been detected. This may help an installer to locate a position where the device is within the line of sight from the SWIR laser scanner.

As soon as the impingement of the SWIR laser scanner has been detected, the device may enter a setup mode, which may allow the selection of various settings, such as screen brightness, location aware position, sending an affirmative signal to indicate installation condition, or scanning a barcode relating to the position.

### SWIR Laser Scanner

Reference is now made to the SWIR laser scanner system 100, shown in FIG. 1 mounted on the ceiling 109 of the store. The SWIR laser scanner system typically comprises an SWIR laser emitter 103, a deflection mirror 104 for aiming the laser beam through the optical window 105 in different directions, a detection mechanism 106 for detection of the fluorescent signal returned from the device, optionally a retroreflection detector (not shown in FIG. 1), and a transceiver antenna 107 for receiving the wireless data package from the device 102, and for transmitting instructions or data back to the device 102. The fluorescent signal detector 106 typically incorporates a filter, blocking most of the solar spectrum as well as the wavelength of the SWIR laser itself, and a detector, typically a diode, for detecting the returning signal. The SWIR laser scanner unit may incorporate a base station control unit 108, configured to supervise the entire operational actions of the SWIR laser scanner unit. Alternatively and additionally, the SWIR laser scanner may also include a network connection (not shown in FIG. 1), allowing remote control of the SWIR laser scanner, as well as transmitting output data such as position of the devices inside the store. The laser scanner may also be used to generate a rough image of the surroundings, which helps mapping the signals onto a store's plan.

### Fluorescence Signal Detector

As previously mentioned, the fluorescence signal detector typically includes a filter for filtering out direct sunlight, while transmitting the fluorescence signal. In some applications, specifically indoor applications, the sunlight blocking filter may be omitted. The sunlight blocking feature may also be replaced by a cover layer on top of the diode, or by selecting a diode which has low response to wavelengths in the visible spectrum, which effectively serves the same purpose as the sunlight blocking filter. At the other end of the communication channel, in the base station, the detector used to detect the fluorescence is typically equipped with a laser blocking filter. The laser blocking feature is very important but may be achieved either by a filter or by physical separation of the laser and scanner system from the fluorescent signal detector or by a filter, preventing the SWIR laser itself from reaching the detector.

An advantage of the filter based system is that the diode may “view” the world through the scanning mirror, and thus have only a narrow field of view, and it can thus be exposed to much less signal compared to a diode which views a very wide field of view. An advantage of the wide field of view system is that it is optically simpler and may operate even without a filter. The fluorescence signal detector may also include a diode for detecting the signal, and typically also an amplifier and an analog-to-the digital converter.

### Central Management Console

Referring back now to the central management console of the store implementation, the present system allows control of the devices installed in the store. Typically, it provides access to at least some of the following features:

1. Listing of all the devices.
2. Position and status of each device, including the battery status, the content playing, the location, the detectability by the SWIR laser, as measured on a nominal scale ranging from YES to NO, a daily/weekly/monthly/annual summary of the detectability check, the number of people counted by a camera or sensor on the device, the number of operations performed using the device, and the status and history of the sensors of the device.
3. Statistical summaries of the status of the complete system, such as the number of devices, the number of operational devices, statistical summaries of sensor measurements over different time periods, such as by the hour, day, week, month, shift, or any other period, the number of devices detected by the SWIR system, a map of the locations from where the devices are visible.
4. The ability to perform the operations on a specific device, such as to update content, to turn off, turn on, change settings, update firmware of a device.
5. The ability to select a set of devices based on criteria, such as all the devices in a region of the area, or all the devices which belong to a specific group, or all the devices which are next to dairy products, and similar criteria.
6. The ability to perform the same operation, such as to update content, on all of these devices automatically.
7. The ability to control the operational parameters of a group of devices, such as, for example, an instruction to “update the content on all the screens on aisle 4”.

### Fluorescence Emitter Characteristics

Referring now to the characteristics of the fluorescent material, it may be a chromophore, a chromophore embedded in a plastic or glass matrix, or a chromophore embedded in a semiconductor matrix, such as a “quantum dot” type semiconductor with the quantum dots tuned to the SWIR laser wavelength.

The fluorescent material is tuned to absorb the SWIR laser, which means that it has a bandgap less than 1.25 eV and typically greater than 0.5 eV, these bandgap levels matching the SWIR region shown in FIG. 6.

The fluorescent material typically absorbs the SWIR laser, and emits fluorescent light, also in the SWIR region, but typically at a longer wavelength. Typically, the emitted light is at least 50 nm longer than the laser, which enables separation of the two signals using filter(s).

A conveniently available SWIR laser source used in some of the systems of the present application, emits at 1310 nm. and generates fluorescence at 1430 to 1450 nm.

If the host material is a plastic or glass, it is generally transparent to the SWIR laser (typically PMMA, PC, Polystyrene, or various glasses would be used). If the host material is a semiconductor, it would typically have a higher bandgap than the fluorescent chromophores, suitable materials being Si, GaAs, Ge, InP and combinations of III-V or II-VI semiconductors.

An alternative to the “quantum dot” approach is a semiconductor material in which a thin layer of fluorescent semiconductor is grown on top of the other layers. A suitable substrate on which to grow the fluorescent material would be the SWIR laser detector.

In some cases, some of the layers in an SWIR laser detector may already be suitable for emitting fluorescent light, and the layer on top of such may be transparent enough to allow some of that fluorescent signal to escape the SWIR laser detector. It is particularly advantageous to use such an SWIR laser detector.

### Typical Installation Procedure

The installation is typically performed in two separate steps; firstly, the installation of the SWIR laser scanner, usually in the base station, and typically mounted on the ceiling or in a location where it has an extensive field of view of the region where the devices are to be installed, and secondly, installation of the devices themselves. There is a need to readily verify that the devices and the SWIR laser scanner are positioned well and in good working conditions, as well as to configure them for their purpose, usually based on the location in which they were placed. As an example, by setting device at a first location to perform a specific task (such as displaying a first ad), while configuring another device at a second location to perform another task (such as displaying a second ad, or a price, or nutritional information for a product). Installation can be done in any order, SWIR laser scanner first, devices first, or some of the devices may be installed before the SWIR laser scanner, while others after it. However typically the SWIR laser scanner is installed before the devices are.

### Structure of the SWIR Laser Scanner

The SWIR laser scanner consists of an SWIR laser emitter 103, emitting an SWIR laser beam 101. A scanning mirror 104 is positioned such that it can direct the laser beam in different directions. The SWIR laser scanner also comprises at least one sensor 106 or 107 for sensing signals returned from the devices, whether the fluorescent signal, a retroreflected signal or the wireless data transmission, a base station controller 108 to control all the above components and to receive and process signals from the sensors, and a data modem (not shown in FIG. 1) either wireless or wired, to send data back to the SWIR laser detector control system 404. If the data modem is wireless, it can also be used to send data to the devices, or the SWIR laser scanner may be equipped with more than one data modems to allow communications to the SWIR laser detector control system 404 as well as to the devices.

However, communication with the devices may be done from a different system and not from the SWIR laser scanner.

The SWIR laser scanner may also be equipped with an indicator, for indication of the installation status of the device. Such an indicator may be at least one of:
1. A light such as a LED, confirming that the SWIR laser is on, has no errors, and the laser is scanning.
2. A sound emitting system.
3. A transmission from the SWIR laser scanner to another system which can be configured to show the status the SWIR laser scanner. This may be the SWIR laser detector control system 404 or the smart phone of the installer, for example.
4. A visible laser, which may visually represent the field of view of the system by scanning it, and may also project messages, on the floor, for example.

### The SWIR Laser Scanner Installation Procedure.

The SWIR laser scanner installation comprises attaching the device to its selected position such as specific point on the ceiling, connecting it to the power supply, and ensuring that the SWIR laser scanner is operating in a “quick approval mode”, to be further explained below. An “installation verifying device”, also further explained below, is used to verify to where lines of sight to the SWIR laser scanner exist and to where they are absent. At the end of the installation the SWIR laser scanner is switched to “normal operation mode”.

### Quick Approval Mode

The SWIR laser scanner scans the room, typically at a fast scan pace. When the SWIR laser scanner detects a device, it may halt its scan for a short time period to allow the device to detect the SWIR laser with high probability and to respond to the SWIR laser. Once that is performed, the laser beam scan can move on at its high scan rate to other devices, to verify which devices are within the SWIR laser scanner's field of view, and to determine the extent of the SWIR laser scanner's field of view. The SWIR laser scanner may also be equipped with a visible laser, essentially aligned with the SWIR laser, to provide a visual representation of the field of view to the installer. Should the installer detect a problem in the field of view coverage of the SWIR laser scanner relative to all of the devices which it intended to be in communication with, the SWIR laser scanner may be repositioned, or the surroundings may be changes, such as, for example, by moving a blocking object.

### Normal Operation Mode

In the normal operation mode, the SWIR laser scanner scans the area, looking for fluorescence signals from devices. When the SWIR laser scanner detects a device, it records the direction in which the device was found, awaits a wireless signal sent from the device indicating its status, and updates the status in the system memory. According to a specific implementation of the system and method, the SWIR laser scanner may direct the SWIR laser to the device for an extended time, in order to charge its internal battery, to allow for long-term continued operation of the device.

### The Installation Verifying Device

The installation verifying device is a distinctive device, carried by the installer, and equipped with an output device adapted to indicate the impingement of the SWIR laser, enabling the installer to detect the region of the field of view of the SWIR laser scanner, and also the correct functional operation of the SWIR laser scanner.

### Installation Procedure of Devices

The device installer may position a device in a specific position, and switch the device to the “installation verification mode”, as explained below. If the SWIR laser scanner is not in “quick approval mode”, the installer switches the SWIR laser scanner to “quick approval mode”. If the device does not indicate it has line of sight to the SWIR laser scanner, the installer should alter its location.

### Installation Verification Mode

In the installation verification mode the device is configured to indicate to the installer that it has detected the SWIR laser, such as by showing a message on the screen, by a visual or auditory confirmation, or by sending a confirmatory wireless signal to the SWIR laser scanner, or to the SWIR laser scanner control system, or to another system such as the Smartphone of the installer.

At the end of a successful installation verification mode, the device may enter a configuration mode allowing it to be configured either by the installer or remotely.

### Additional Safety Features of the System

Besides the above mentioned search functionality of the SWIR laser scanner, the presently described SWIR laser scanner include a number of electrical features of the SWIR laser scanner which increase safety in the use of the system.

There are two distinct, safety related, functionalities which the control system of such SWIR laser scanner has to perform, whether executed by a single controller, or by separate controllers for different aspects of the total safety related total control needs. These two functionalities have different objectives and operation, even though they may be implemented from the same controller or controllers.

The first functionality is related to the overall safety of a technically operational system, and its objective is to ensure that the system does not cause harm. That function is accomplished by estimating the probability of dangerous exposure of a person to the laser beam, and comparing the likelihood of such exposure to both internal and external standards. If the criteria programmed into the controller are such that the operational situation indicates the likelihood of dangerous exposure, the controller is instructed to turn the laser off, lower its power or direct it elsewhere. The controller generally has a number of different methods to perform these actions in a technically functional system, including such actions as reducing or stopping the power to the laser driver, directing the laser to a safe place, disconnecting the anode or cathode power leads, and others. Such methods are part of the normal safety procedures implemented by such a laser system, and as described in a number of patent applications owned by the present applicant.

The second functionality is directed at system diagnostics, aimed at detecting malfunctions in the system, and responding to them safely. In this implementation, a parameter such as generated or reflected SWIR laser power is measured, and may be compared to another parameter, for instance the laser current and/or its temperature, the comparison or the original measured parameter or a function of it, being tested against some predetermined limits, and a response of the controller generated if the situation deems that necessary. Such safety functionality is described in International Patent Application Publication No. WO 2018/211,506 for “Flexible Management System for Optical Wireless Power Supply” and No. WO/2019/064305 for “Fail-Safe Optical Wireless Power Supply”, both co-owned by the present applicant. Additionally, the controller should also be diagnostically safeguarded, typically, by both internal and external watchdogs to ensure correct functionality, such that it is configured to terminate the laser, if the controller is showing any apparent malfunction. In some implementation, a single watchdog or other means of ensuring proper operation may be used.

One particular fault that may arise is related to the temperature protection of the system, and particularly of the laser. As the system warms up, a situation can be reached where the temperature of the laser emitter becomes excessive, and the thermal safety switch shuts down the entire system, rendering the location being served by the system as unprotected. According to a further aspect of the system diagnostic routines of the SWIR laser scanner, the thermal safety criteria are relaxed somewhat, such that a complete system shutdown is not activated by a local thermal overheating in the laser, but rather, the power of the emitted laser beam is reduced to some lower level, while all of the system functions continue to run, such that the system can recover from a thermal overload without losing its entire operational capabilities.

There remains, however, one mishap which is not readily safeguarded by such protective control features, and that is the situation in which a physical short circuit, or even an indirect short circuit such as could be caused by a failed component allowing current passage even when not enabled by the control function, allows current flow though the laser diode source, even when none is allowed by the controller or controllers. Such a short circuit enable the system to operate in a mode that would project a beam of high power in an unsafe manner. In any such situation, the normal safety precautions may not be operative, as such a short circuit may lead to a drop in system voltage below some component or sub-system operating voltage, or the high temperature resulting from the malfunction may cause some components to fail, or other consequences of the short circuit may lead to a controller failure, any of such situations possibly enabling passage of a current which may empower laser emission when none should have been permitted by the supposedly electronically sound control system.

The presently described system incorporates a number of features which ensure that in such a possibility, the system is provided with protection that will prevent unintended laser emission under such circumstances in which physical or electronically virtual short circuits enables an operating current to pass through the laser diode. Such features include both physical insulation of the laser leads, enabling continued operation of a controller using current storage features, and independently controlled switches in the anode and cathode leads of the laser that are activated by a novel power supply voltage arrangement, thereby providing protections hitherto unavailable in conventional laser transmission systems.

Reference is now made to FIG. 7, which shows an additional safety feature of the presently described SWIR laser scanner, used to increase the safety of operation of the system, as shown in co-pending Israel Patent Application 286842 for “A System for Location and Charging of Wireless Power Receivers”, co-owned by the present applicant. The diagram shows the arrangement of controller and safety features which are generally used in current systems, together with additional features which provide the current system with protection unavailable in previous systems. Current laser transmission systems often provide protection in the event that the system determines, typically by noting an unexpected difference between the transmitted power some other parameter such as laser reflection, that the beam has intercepted an unexpected body in its path from the transmitter to the device. As is conventionally performed, the primary control of the laser emission is obtained through the laser power supply, hereinafter called the laser driver, which controls the current supplied to the laser diode to generate laser emission. The laser driver is subject to the control of the entire transmission system whose controller traditionally provides various safety features to ensure that the laser emission is terminated by the laser driver power supply in the event of any dangerous conditions arising. Such dangerous conditions generally include predefined malfunctions in any of the control system functions. However, as previously stated, there are certain malfunctions not directly related to the control functions, that may not be effectively handled by conventional safeguards, and it is such situations that the current system attempts to address. Situations may arise when a fault results in an operating condition which prevents the controller from operating reliably, and at the same time causes the system to be in an unsafe condition. Such situations include, for instance, an unsuitable voltage being applied to an input to the controller and at the same time to the laser diode, when no such voltage should have been provided. Other conditions in which a fault may cause the controller to function unreliably are a voltage outside the operational specifications of the controller, or exposure to a temperature outside the operational temperature of the controller, or to an electric or magnetic field outside the operational specifications of the controller. Such faults may arise not from the operation of the controller, but rather because of a mishap unrelated with the operation of the controller, such as a physical short circuit, as mentioned above, or an unexpected circuit connection because of a failed component. In such a condition, the controller may be non-operational and unable to successfully cause the laser driver power supply to shut down, or the laser diode itself may still be powered because of the physical short circuit or the circuit malfunction because of a failed component. A number of solutions to deal with such instances are now presented.

In the system of FIG. 7, the laser diode is powered by a laser driver, which receives its instructions from the system controller I. This main controller is programmed to cause the laser to turn on and off and to adjust its power level for the various scan, charge, and idling operations, in order to operate the system, and to ensure that users are always safe. The driver sends the appropriate drive current to the laser diode, and the input and output current connections of the laser diode, namely to the anode and from the cathode, are shown connected by insulated cables, to two auxiliary gated switches controlled by a gate controller. The enablement of current from the laser driver to the anode of the laser diode, and from the cathode to the ground of the circuit, or to the negative terminal of the laser driver is thus controlled by the two switches, and this ON/OFF control is in addition to the basic level control provided to the laser current from the laser driver itself. These two switches, which are held in the conducting state (hereinafter “closed”) by control voltages on the gate, are used for additional safety, enabling two additional and independently redundant methods of terminating the current to the laser, which can be implemented separately or both together. The common method of performing the function of closing down the laser is by controlling the laser driver which provides the current to the laser diode. However, this may not always achieve its desired function in the event of a short circuit providing current to the laser diode other than through the laser diode driver. It is under these circumstances, for instance, that the two switches provide the additional safety method of shutting down the laser emission when conditions necessitate such a close down.

Although such gated switches have been used in previous systems, to provide an additional channel for interrupting the laser diode current, as indicated by the control lines to the switch gates from the main controller I, the novel use of such switches in the presently described system arises from the manner in which the switches are powered, relative to the other electronic modules and functions of the system. The operation of these two gated switches makes use of the fact that most infra-red laser diodes typically operate at low voltages, in the region of below 1.5V. This is a significantly lower voltage than that used by most other electronic components associated with the electronic circuitry of the system, being generally based on Si semiconductor technology, which cannot operate at such a low voltage. which have a higher operating voltage, typically 1.7V, 3.3V, 5V or 12V or others.

In order to implement this scheme, both the anode switch and the cathode switch can be controlled by an additional controller function, called in FIG. 7, Controller II, System Monitor, which could be an additional function of the main controller that controls the current level to the laser driver, or it could be an additional and separate gate controller, whose function is to stop lasing by opening the switch or switches under conditions when the main laser driver controller does not do so when instructed.

At least one of the two switch gates is arranged to be in the normally non-conducting state, and the laser current is enabled during normal operation by holding the gate in its conducting state by a voltage supplied by controller II. When that latching voltage drops, the gate will revert to the open non-conducting state. The switch gates, or more specifically, the gate controller circuits, are driven from the system main power supply by a separate operating voltage, higher than the voltage supplied to the system controller or the laser driver, or any other electronic function in the system. In the event that a physical short circuit occurs, resulting in the application of a voltage more than 1.5V onto the anode lead of the laser diode, the laser diode will turn on and emit a laser beam, even in a situation when the laser driver is in its off-state and the anode switch is non-conducting. The same situation applies if such a circuit malfunction occurs in the laser driver, and a current is delivered to the laser even when not instructed to be in an ON condition. Since the laser diodes operate at 1.5 v or less, and inadvertent application of another voltage present in the circuitry will be higher than 1.5 v, the increased current drawn from the main power supply may cause a fall in the main power supply voltage to all of the control functions of the system, or alternatively, a fall to a level which is not high enough to reliably operate the controller or its watchdog. Since the gates of the switches are actuated at a higher voltage than either the controller or its watchdog, or both, the fall in voltage will switch the gated switches to their non-conducting state independently of the situation of the controller or its watchdog. Bringing either of those switches to the non-conducting state will thus stop the diode laser current, and bring the system to a safe state, regardless of the functional action of any of the other circuit controllers or electronic safeguard mechanisms of the system.

As an alternative and second method of protecting the system from such a short circuit fault, the main controller may be powered from its power supply with a parallel energy storage device, such as a capacitor, a battery or a coil, thus enabling it to operate for a time long enough to cause the laser to turn off when such a fault is detected, even when power to the controller is turned off. The watchdog may also reset the main controller correctly if it stops operating correctly. Typically, such a reset function is also configured to cause the laser to be turned off until the controller has resumed normal operation. At least one of the switches, anode or cathode, is normally non-conducting, such that if the controller is not powered on, the laser, under normal conditions, cannot be powered on.

In a second alternative situation, if the main controller voltage drop is sufficient to cause the main controller to malfunction, and therefore not to respond by reducing the unexpected and uncontrolled laser diode current, the feature of making the switch operation dependent on a higher operating voltage than the system controller or the laser driver, means that the switches will open, and hence terminate the laser diode current regardless of what the system controller or the laser driver are attempting to do.

Thirdly, a main power switch may be provided, enabling the controller to control the power supply to all the parts mechanically accessible to any point in the circuit electrically connected to the laser anode or cathode. This protection is especially important when a C-mount laser diode is used, since such a C-mount has large areas of exposed metallic surfaces being part of the diode conductors, which could readily be short circuited to ground or to another live metallic contact within the laser generator enclosure, in the event of a mechanical intrusion, or a mechanical fault, such as a loose wire connection becoming free.

Fourthly, all the points in the circuit, including the laser sub-mount, should be electrically insulated. This may be a difficult task to achieve completely without having an effect on the cooling requirements of the laser diode. Consequently, it is advisable that this safety feature be relied upon only in conjunction with at least one of the other features described hereinabove.

Finally, a laser power metering system may be added to the system for comparing the measured laser output power of the laser diode to the expected laser output power according to the settings of the laser diode controller, or, in the event of the use of more than one control system of any of the above described safety arrangements, according to the settings of the controllers. The expected output power should depend on the operational state of the system, namely whether in scan/search mode, or charge mode. Should this metering system find a significantly higher measured power than is programmed by the controller settings, this indicates a system error or a system mishap, and the lasing should be terminated by use of one or more of the switches mentioned above. The power meter may be a separate controller or the central controller or even a component in, for example, the laser driver.

The beam emitted from a laser diode typically expands comparatively rapidly with distance, as compared with other types of lasers. Consequently, a collimation system is needed to generate a more collimated beam needed for efficient charging.

The collimation system is typically also controlled by a controller, advantageously the same controller as used to control the current to the laser diode. The collimation system may operate by adjusting the axial position of a collimating lens or lens system, thereby controlling the beam expansion, the Rayleigh length and beam width. The axial position may be any form of linear actuator, such as magnetic, thermal, piezo-electric, or electro-mechanical, and the actuator may be controlled by means of another switch whose control input may be made through the switch gate. Alternatively, the collimation may be changed by modifying the laser parameters, such as the laser chip position, the laser wavelength, the beam divergence or another characteristic, by changing an electrical input signal to the laser diode.

When switching to scan mode, the controller(s) allows current to flow through both laser diode switches, and also adjusts the current flow through the lens position actuator, or through another system element to control the beam divergence as mentioned above, to bring the collimation of the laser to “wide mode”, in which the beam expands towards the end of the system's intended operation range. When switching off, the controller typically blocks the current through at least one of the laser diode switches.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. Furthermore, it is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1: A system for monitoring at least one electronic device in a region of interest, the system comprising:
a laser scanner unit for transmitting a laser beam into the region of interest;
a laser detector module mounted on at least one electronic device, the laser detector module adapted to emit fluorescent illumination when the laser beam impinges thereon; and
a fluorescence detection module on the laser scanner unit, adapted to notify a system controller of the detection of fluorescence illumination from the laser detector module on the electronic device,
wherein the at least one electronic device has at least a lower state of electronic activity, and a higher state of electronic activity, and the intensity of the emitted fluorescent illumination on impingement of the laser beam on the laser detection module is dependent on the state of electronic activity of the electronic device.

2: A system according to claim 1, further comprising a wireless transceiver adapted to enable transmission of data from the laser scanner unit to the electronic device, on notification by the system controller of detection at the laser scanner unit, of fluorescence illumination from the device,
wherein the data transmitted to the electronic device comprises at least one of information for display by the device, or instructions for execution by the device.

4: A system according to claim 2 wherein the wireless transceiver is further adapted to enable transmission of data from the electronic device to the laser scanner unit, the data comprising at least one of identity information of the electronic device and an electronic status of the electronic device.

4: A system according to any of the previous claims, wherein the intensity of the fluorescence illumination provides an indication of a non-functioning electronic device.

5: A system according to any one of the previous claims, wherein the electronic device further comprises a battery enable its operation, and the laser beam is operative to provide power for charging the battery.

6: A system according to any one of the previous claims, wherein the laser scanner unit further comprises a scanning mirror adapted to scan the region of interest such that the laser beam can locate the position of an electronic device in the region of interest by detection of the fluorescence illumination generated by impingement of the laser beam on the electronic device.

7: A system according to any one of the previous claims, wherein the laser detector module on the electronic device comprises an optical filter adapted to reduce the sensitivity of the laser detector module to daylight.

8: A system according to any one of the previous claims, wherein the laser beam has a wavelength within the short wavelength infra-red (SWIR) region.

9: A system according to any one of the previous claims, wherein the electronic device is any of an electronic faucet, a remote electronic sensor, an information display screen; an electronically operated window shade, an electronically operated window, an electronic label, and an electronically operated camera system.

10: An electronic device for communicating with a base station, the electronic device comprising:
a laser detector module adapted to emit fluorescent illumination, and to enable output of an electrical signal, when a laser beam from the base station impinges on the laser detector module;
a wireless transmitter adapted to transmit a data package from the electronic device to the base station when a device controller receives the electrical signal from the laser detection module indicating impingement of the laser beam from the base station; and
a wireless receiver adapted to receive from the base station at least one of (i) information for display by the electronic device, or (ii) instructions for execution by the electronic device, if the base station detects from the device, at least one of (a) fluorescence illumination or (b) a data package.

12: An electronic device according to claim 11 wherein the data package sent to the base station comprises at least one of identity information of the electronic device, and, a state of electronic activity of the electronic device.

13: An electronic device according to either of claims 11 and 12 wherein the intensity of the fluorescent illumination on impingement of the laser beam is dependent on the state of electronic activity of the electronic device.

14: An electronic device according to claim 13, wherein the intensity of the fluorescence illumination provides an indication of a non-functioning electronic device.

15: An electronic device according to any one of claims 11 to 14, wherein the electronic device further comprises a battery for its operation, and the laser beam is operative to provide power for charging the battery.

16: An electronic device according to any one of claims 11 to 15, wherein the laser beam from the base station is configured to scan a region in which the electronic device is situated, such that the laser beam can locate the position of the electronic device in the region by detection of the fluorescence illumination generated by impingement of the laser beam on the laser detector module of the electronic device.

17: An electronic device according to any one of claims 11 to 16, wherein the laser detector module on the electronic device comprises an optical filter adapted to reduce the sensitivity of the laser detector module to daylight.

18: An electronic device according to any one of claims 11 to 17, wherein the laser beam has a wavelength within the short wavelength infra-red (SWIR) region.

19: An electronic device according to any one of claims 11 to 18, wherein the electronic device is any of an electronic faucet, a remote electronic sensor, an information display screen; an electronically operated window shade, an electronically operated window, an electronic label, and an electronically operated camera system.

20: A system for communication with at least one electronic device in a region of interest, the system comprising:
a laser scanner unit for transmitting a laser beam into the region of interest;
a laser detector module mounted on an electronic device, the laser detector module adapted to emit fluorescent illumination when the laser beam impinges thereon;
a fluorescence detection module on the laser scanner unit, adapted to notify a system controller of the detection of fluorescence illumination from the laser detector module on the electronic device; and
a monitoring system adapted to:
(i) remotely monitor the electronic device wirelessly, for receipt of information from the system controller indicating detection at the laser scanner unit of fluorescence illumination from the electronic device, and,
(ii) on receipt of information from the system controller indicating detection at the laser scanner unit of fluorescence illumination from the electronic device, enable control of at least one function of the electronic device.

21: A system according to claim 20, wherein the information from the system controller further comprises at least one of identity information of the electronic device and an electronic status of the electronic device.

22: A system according to claim 20, wherein the control of at least one function of the electronic device comprises at least one of instructing the electronic device to display information, or instructing the device to execute a predetermined function.

23: A system according to any one of claims 20 to 22, wherein the intensity of the fluorescence illumination provides an indication of a non-functioning electronic device.

24: A system according to any one of claims 20 to 23, wherein the electronic device further comprises a battery enable its operation, and the laser beam is operative to provide power for charging the battery.

25: A system according to any one of claims 20 to 24, wherein the laser scanner unit further comprises a scanning mirror adapted to scan the region of interest such that the laser beam can locate the position of an electronic device in the region of interest by detection of the fluorescence illumination generated by impingement of the laser beam on the electronic device.

26: A system according to any one of claims 20 to 25, wherein the laser detector module on the electronic device comprises an optical filter adapted to reduce the sensitivity of the laser detector module to daylight.

27: A system according to any one of claims 20 to 26, wherein the laser beam has a wavelength within the short wavelength infra-red (SWIR) region.

28: An electronic device according to any one of claims 20 to 27, wherein the electronic device is any of an electronic faucet, a remote electronic sensor, an information display screen; an electronically operated window shade, an electronically operated window, an electronic label, and an electronically operated camera system.
